(19) United States
(12) Patent Application Publication
(10) Pub. No.: US 2018/0372219 A1
(43) Pub. Date: Dec. 27, 2018

(54) Control Method For A Ball-Type Continuously Variable Planetary Related Application

(71) Applicant: Dana Limited, Maumee, OH (US)

(72) Inventors: Jeffrey M. David, Cedar Park, TX (US); T. Neil McLemore, Georgetown, TX (US); Benjamin L. Powell, Austin, TX (US)

(21) Appl. No.: 16/008,490

(22) Filed: Jun. 14, 2018

Related U.S. Application Data
(60) Provisional application No. 62/523,008, filed on Jun. 21, 2017.

(51) Int. Cl. F16H 61/664; F16H 37/02; F16H 15/50

(52) U.S. Cl. CPC F16H 61/6647; F16H 37/022; F16H 15/28; F16H 2061/6641; F16H 15/503

(57) ABSTRACT

A control system to control the operating conditions of a Continuous Variable Transmission configured to receive signals and execute commands based at least in part on a driver's torque or load request. The control system includes a ratio controller incorporating binary logarithmic processes applied to a commanded CVP ratio and an actual CVP ratio. The binary logarithmic processes provide linearized signals to a PID controller to thereby provide a commanded CVP ratio to form a commanded CVP shift actuator position.

### RELATED APPLICATION

The present application is a divisional application of U.S. Provisional patent application Ser. No. 62/523,008, filed on Jun. 21, 2017, which is incorporated herein by reference in its entirety.

### BACKGROUND

Automatic and manual transmissions are commonly used in the motor vehicle industry. Automatic and manual transmissions have become more complicated as the need to improve fuel and minimize emissions increases. To improve fuel economy and minimize the emissions the engine speed must be controlled. This control of the engine speed in conventional transmissions can typically be done by adding extra gears. However, by increasing the number of gears, the cost and overcall complexity of the transmissions also increases.

In addition to these conventional transmissions, Continuously Variable Transmissions (CVT) have also been developed for the motor vehicles. There are many types of CVTs including: belts with variable pulleys, toroidal, conical, etc. The main principle of a CVT is that it enables the engine to run at its most efficient rotation speed by steplessly changing the transmission ratio as a function of the vehicle speed. However, CVTs still experience limitations regarding torque peaks and controllability of the speed ratio in a number of different applications. Thus, there is a need for an improved method of controlling a CVT without increasing the cost and complexity of the transmission.

### SUMMARY

Provided herein is a computer-implemented system for a ball-type planetary variator (CVP) having a plurality of tiltable balls coupled to and supported in a carrier assembly, the computer-implemented system including: a digital processing device having an operating system configured to perform executable instructions and a memory device; a computer program including a sequence of instructions executable by the digital processing device, the computer program having a ratio controller configured to control a plurality of operating conditions of the CVP; and a plurality of sensors configured to monitor the operating conditions of the CVP including: a CVP ratio command and an actual CVP ratio, wherein the ratio controller includes a first logarithmic process applied to the CVP ratio command to form a linearized CVP ratio command and a second logarithmic process applied to the actual CVP ratio to form a linearized actual CVP ratio, and wherein the ratio controller commands a change in the carrier assembly position of the CVP based at least in part on the linearized CVP ratio command and the linearized actual CVP ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that can be used in the variator of FIG. 1.

FIG. 3 is an illustrative view of different tilt positions of the variator of FIG. 1.

FIG. 4 is a block diagram of a control system implementing the variator of FIG. 1.

FIG. 5 is a block diagram of a ratio controller implemented in the vehicle control system of FIG. 4.

### DETAILED DESCRIPTION OF THE PREFERRED EMBODIMENTS

The preferred embodiments relate to controlling the operating conditions of a Continuous Variable Transmission with an electronic control system configured to receive signals and execute commands based at least in part on a driver's/operator's torque or load request. The driver can give input to the vehicle in various ways including: the brake pedal, the accelerator pedal, and other control button, switches, or knobs located within reach of the driver. The brake pedal and accelerator pedal input signals are mainly related to the requested total vehicle action. The control system described herein uses a plurality of measurements available which give information on the vehicle status. Some of the measurements or signals are: engine speed, transmitted torque, transmission output speed, temperatures, gearbox settings, brake pedal position, accelerator pedal position (sometimes referred to as a gas pedal), engine throttle position, among others.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments can include several novel features, no single one of which is solely responsible for its desirable attributes or which is essential to practicing the preferred embodiments described.

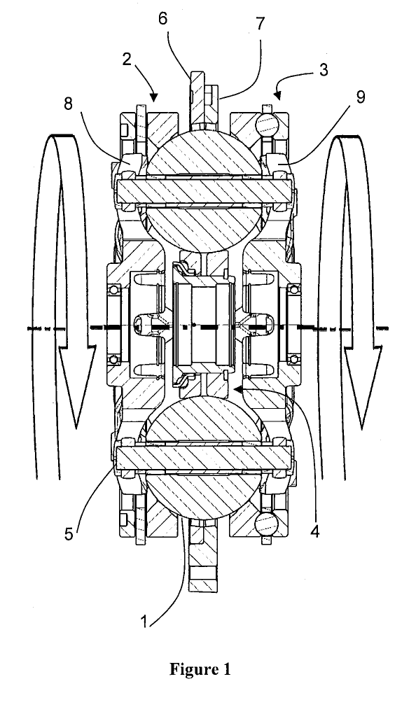

Provided herein are configurations of CVTs based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two traction ring (disc) assemblies contact the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member 6, and vice versa. In some embodiments, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members 6, 7 to impart a tilting of the axles 5 and thereby adjusts the speed ratio of the variator. Other types of ball CVTs also exist, like the one produced by Milner, but are slightly different.

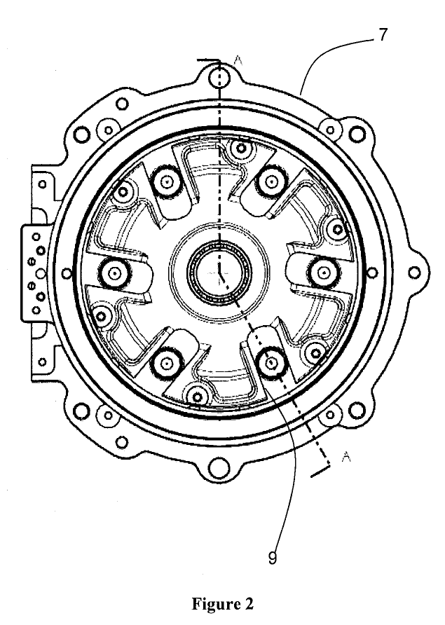

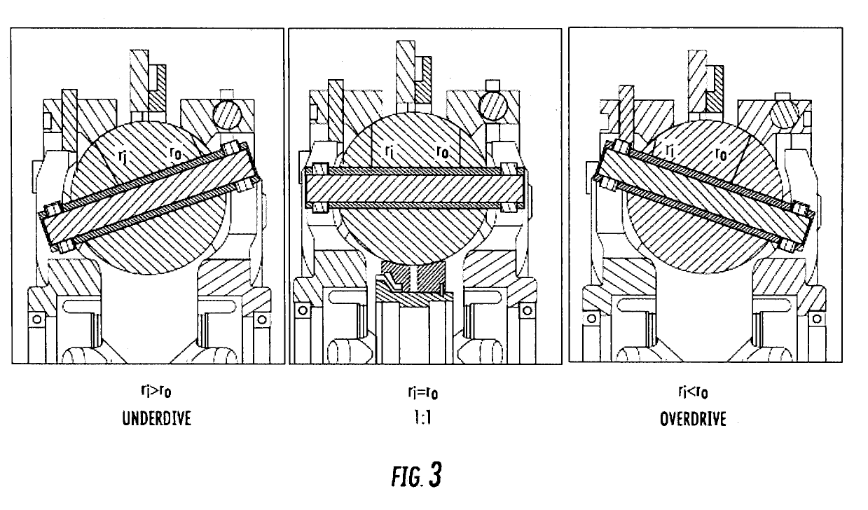

The working principle of such a CVP of FIG. 1 is shown on FIG. 2. The CVP itself works with a traction fluid. The lubricant between the ball and the rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler.

Embodiments disclosed here are related to the control of a variator and/or a CVT using generally spherical planets each having a tiltable axis of rotation that is adjusted to achieve a desired ratio of input speed to output speed during operation. As used herein, the term “gamma” or “gamma angle” or “γ” refers to the tilt angle the ball axis makes with the longitudinal axis of the transmission. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here may operate in both tractive and frictional applications.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.” It should be understood, that speed ratio droops with increasing torque due to the local shearing of the traction fluid at the contacting components. As speed ratio droops the torque ratio rises, and thus the CVP naturally exhibits some degree of response to changing torque demands. Control methods described herein are optionally configured to account for the speed ratio droop through appropriate feedback and mapping of the transmission hardware.

For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means. As used herein, a sensor is optionally configured to be a physical device, a virtual device, or any combination of the two. For example, a physical device is optionally configured to provide information to form a parameter for use in an electronic module. In some embodiments, as used herein, a speed sensor is either a physical device or a virtual device implemented in software to sense a speed of a rotating component.

Those of skill will recognize that in some embodiments, the various illustrative logical blocks, modules, circuits, and algorithm steps described in connection with the embodiments disclosed herein, including with reference to the control system described herein, for example, are implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein are implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general purpose processor or processing device may be a microprocessor, but in the alternative, the processor may be any conventional processor, controller, microcontroller, or state machine. In some embodiments, a processor will be implemented as a combination of computing devices, e.g., a combination of a DSP and a microprocessor, a plurality of microprocessors, one or more microprocessors in conjunction with a DSP core, or any other such configuration. In some embodiments, software associated with such modules resides in a memory device such as in RAM memory, flash memory, ROM memory, EPROM memory, EEPROM memory, registers, a hard disk, a removable disk, a CD-ROM, or any other suitable form of storage medium known in the art. In some embodiments, an exemplary storage medium is coupled to the processor such that the processor reads information from, and writes information to, the storage medium. In alternative embodiments, the storage medium is integral to the processor. In some embodiments, the processor and the storage medium reside in an ASIC. For example, in some embodiments, a controller for use of control of the CVT includes a processor (not shown).

In some embodiments, the Control System for a Vehicle equipped with a continuously variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application. Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program includes one sequence of instructions. In some embodiments, a computer program includes a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

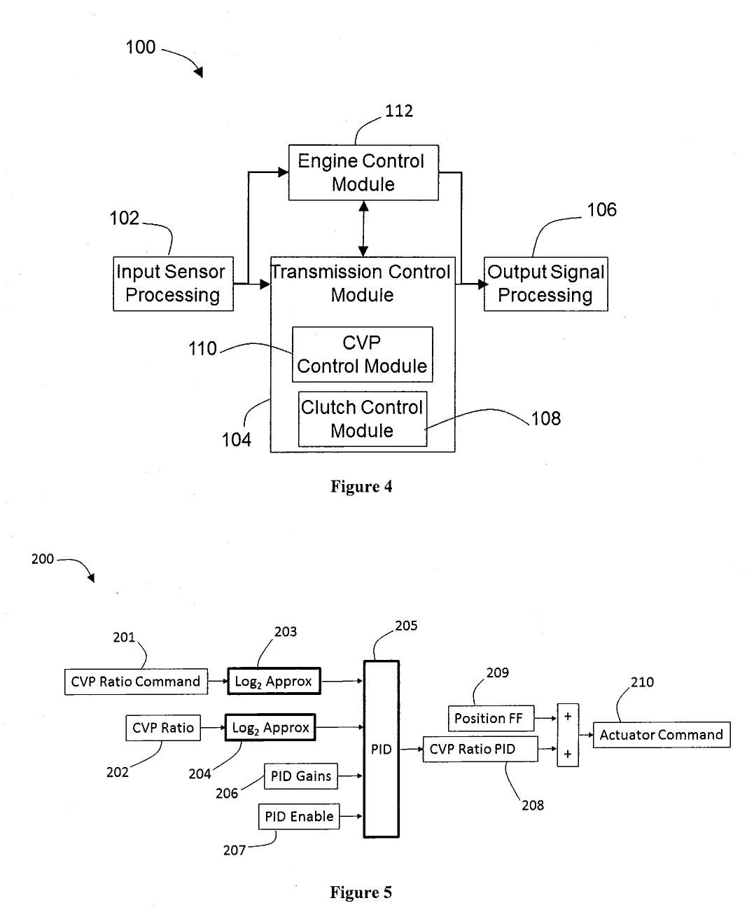

Referring now to FIG. 4, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others.

In some embodiments, the signal processing module 102 optionally includes various sub-modules to perform routines such as signal acquisition, signal arbitration, or other known methods for signal processing.

The output signal processing module 106 is optionally configured to electronically communicate to a variety of actuators and sensors.

In some embodiments, the output signal processing module 106 is configured to transmit commanded signals to actuators based on target values determined in the transmission control module 104.

The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed herein. It should be noted that the CVP control sub-module 110 optionally incorporates a number of sub-modules for performing measurements and control of the CVP.

In some embodiments, the vehicle control system 100 includes an engine control module 112 configured to receive signals from the input signal processing module 102 and in communication with the output signal processing module 106. The engine control module 112 is configured to communicate with the transmission control module 104.

Referring now to FIG. 5, in some embodiments, the control system includes a ratio controller 200 is adapted to receive a CVP ratio command 201 from another module within the CVP control sub-module 110. The ratio controller 200 receives an actual CVP ratio 202 from a module within the transmission control module 104. The CVP ratio command 201 is passed through a first logarithmic process 203. The actual CVP ratio 202 is passed through a second logarithmic process 204. The first logarithmic process 203 and the second logarithmic process 204 are configured to apply a binary logarithm, which is a logarithm to the base 2. The first logarithmic process 203 applies the binary logarithm to the CVP ratio command 201 to form a linearized CVP ratio command. The second logarithmic process 204 applies the binary logarithm to the actual CVP ratio 202 to form a linearized CVP ratio.

In some embodiments, the ratio controller 200 is adapted to receive a calibrateable matrix 206 containing gain values for a PID controller 205. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable. The PID controller 205 receives an enable signal 207 that is optionally provided by a module in the transmission controller 104. The PID controller 205 receives the output of the first logarithmic process 203 and the second logarithmic process 204 and determines a PID CVP Ratio command signal 208. In some embodiments, the PID CVP Ratio command signal 208 is optionally added to a feed forward position signal 209 to form an actuator command 210. The feed forward position signal 209 is provided by a module within the CVP control sub-module 110. The actuator command 210 is delivered to the output signal processing module 106 to impart a change in a CVP shift actuator coupled to the first carrier member 6 and/or the second carrier member 7 to change the position of the carrier members 6, 7, for example. During operation of the CVP, the ratio controller 200 improves stability of the actual CVP ratio 202 and responsiveness to changes in the CVP ratio command 201 as compared to controllers that do not incorporate linearization with binary logarithmic processes.

Provided herein is a vehicle including: a continuously variable planetary (CVP), wherein the CVP is a ball-type variator assembly having a first traction ring assembly and a second traction ring assembly in contact with a plurality of balls, wherein each ball of the plurality of balls has a tiltable axis of rotation supported by a first carrier member and a second carrier member, wherein a rotation of the first carrier member with respect to the second carrier member corresponds to a change in the tiltable axis of rotation; and a controller configured to control a CVP ratio using a ratio controller, wherein the ratio controller is configured to receive a CVP ratio command and an actual CVP ratio, and wherein the ratio controller applies a binary logarithm to the CVP ratio command to form a linearized CVP ratio command, and applies a binary logarithm to the actual CVP ratio to form a linearized actual CVP ratio.

In some embodiments, the ratio controller further includes a PID controller configured to provide a PID CVP ratio command based on the linearized CVP ratio command and the linearized actual CVP ratio.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the invention. It is intended that the following claims define the scope of the preferred embodiments and that methods and structures within the scope of these claims and their equivalents be covered thereby.

What is claimed is:

1. A computer-implemented system for a ball-type planetary variator (CVP) having a plurality of tiltable balls coupled to and supported in a carrier assembly, the computer-implemented system comprising:
a digital processing device comprising an operating system configured to perform sequences of executable instructions and a memory device;
a computer program including a sequence of instructions executable by the digital processing device, the computer program comprising a ratio controller configured to control a plurality of operating conditions of the CVP; and
a plurality of sensors configured to monitor the operating conditions of the CVP comprising:
a CVP ratio command,
an actual CVP ratio,
wherein the ratio controller comprises a first logarithmic process applied to the CVP ratio command to form a linearized CVP ratio command and a second logarithmic process applied to the actual CVP ratio to form a linearized actual CVP ratio, and
wherein the ratio controller commands a change in the carrier assembly position of the CVP based at least in part on the linearized CVP ratio command and the linearized actual CVP ratio.

2. The computer-implemented system of claim 1, wherein the ratio controller further comprises a PID controller configured to receive the linearized CVP ratio command and the linearized actual CVP ratio.

3. The computer-implemented system of claim 2, wherein the PID controller returns a PID CVP ratio command based on the linearized CVP ratio command and the linearized actual CVP ratio.
